(19) United States
(12) Patent Application Publication
(10) Pub. No.: US 2017/0190048 A1
(43) Pub. Date: Jul. 6, 2017

(54) Marsupial Robotic System

(71) Applicant: Anthrotronix, Inc., Silver Spring, MD (US)

(72) Inventors: Jack M. Vice, Orlando, FL (US); Anna D. Skinner, Washintgon, DC (US); Joshua M. Nichols, Washington, DC (US)

(73) Assignee: Anthrotronix, Inc., Silver Spring, MD (US)

(21) Appl. No.: 15/393,647

(22) Filed: Dec. 29, 2016

Related U.S. Application Data
(60) Provisional application No. 62/273,798, filed on Dec. 31, 2015.

(51) Int. Cl. B25J 5/00

(52) U.S. Cl. CPC B25J 5/007; G05B 2219/40306; G05B 2219/40405; G05B 2219/40442; G05B 2219/40572; G05B 2219/40621; Y10S 901/01

(57) ABSTRACT

The embodiments relate to a distributed marsupial robotic system. The system includes a parent component having a sensor suite to obtain and process environment data via a parent pattern classification algorithm, and one or more child components each having a sensor suite to obtain and process environment data via a child pattern classification algorithm. Each sensor suite includes one or more sensor devices in communication with a processing unit and memory. Each child component is configured to dock to the parent component, and to separate from the parent component in response to a deployment signal. Each child component obtains environment data during separation. The parent component is configured to construct a map of the environment by receiving and integrating the data obtained by each child component.

### CROSS REFERENCE TO RELATED APPLICATION(S)

This application is a non-provisional patent application claiming the benefit of the filing date of U.S. Provisional Patent Application Ser. No. 62/273,798, filed Dec. 31, 2015, and titled “Marsupial Robotic System” which is hereby incorporated by reference.

### BACKGROUND

The embodiments described herein relate generally to robotics. More specifically, the embodiments described herein relate to a distributed marsupial robotic system with multiple linked systems of robots.

A marsupial relationship refers to a biological relationship between marsupial animals. With respect to robotics, a marsupial robot refers to a system that includes a team of robots and a relationship among the robots that comprise the team. The configuration of a marsupial robotic system generally includes a carrier robot, also referred to as a container robot, and robot team members referred to as passenger robots. It is understood that the container robot is employed to traverse terrain which the passenger robots may find difficult for various reasons, including power consumption. The container robot delivers the passenger robots to a work location. The passenger robots may be homogenous or heterogeneous. The container and the passenger robots provide services to each other. For example, in one embodiment the container robot provides transportation and the passenger robots provide complementary or supplemental sensor.

### SUMMARY

The aspects described herein include a distributed marsupial robotic system.

According to one aspect, a system, method, and computer program product are provided in conjunction with the marsupial robotic system. The system includes a parent component having a sensor suite to obtain and process environment data via a parent pattern classification algorithm. The system further includes one or more child components each having a sensor suite to obtain and process environment data via a child pattern classification algorithm. Each sensor suite includes one or more sensor devices in communication with a processing unit and memory. Each child component communicates with the parent by wireless communication and/or wired communication. Each child component is configured to dock to the parent component, and to separate from the parent component in response to a deployment signal. Each child component obtains environment data during and after separation from the parent. The parent component is configured to construct a map of the environment by receiving and integrating the data obtained by each child component.

Other features and advantages will become apparent from the following detailed description of the presently preferred embodiment(s), taken in conjunction with the accompanying drawings.

### BRIEF DESCRIPTION OF THE SEVERAL VIEWS OF THE DRAWINGS

The drawings referenced herein form a part of the specification. Features shown in the drawings are meant as illustrative of only some embodiments, and not all embodiments, unless otherwise explicitly indicated.

FIG. 1 depicts a block diagram illustrating a diagram of a hierarchical representation of a distributed marsupial robotic system.

FIG. 2 depicts a block diagram illustrating a distributed marsupial robotic system, according to an embodiment.

FIG. 3 depicts a flow chart illustrating a de-coupling of one or more child components from a parent component in the distributed marsupial robotic system, according to an embodiment.

FIG. 4 depicts a flow chart illustrating a re-coupling of one or more child components to the parent component in the distributed marsupial robotic system, according to an embodiment.

FIG. 5 depicts a block diagram illustrating an example of multi-camera mapping, according to an embodiment.

FIG. 6 depicts a block diagram illustrating an example of a mechanism for enabling docking of a child component to a parent component.

FIG. 7 depicts a block diagram illustrating exemplary component hardware for implementation in data gathering and processing.

FIG. 8 depicts an illustrative example of a cloud computing environment, in accordance with an embodiment.

FIG. 9 depicts an illustrative example of abstraction model layers in accordance with an embodiment.

### DETAILED DESCRIPTION

It will be readily understood that the components of the embodiments described herein, as generally described and illustrated in the Figures herein, may be arranged and designed in a wide variety of different configurations. Thus, the following detailed description of the embodiments of the method, computer program product, and system, as presented in the Figures, is not intended to limit the scope of the claims, but is merely representative of selected embodiments.

Reference throughout this specification to “a select embodiment,” “one embodiment,” or “an embodiment” means that a particular feature, structure, or characteristic described in connection with the embodiment is included in at least one embodiment. Thus, appearances of the phrases “a select embodiment,” “in one embodiment,” or “in an embodiment” in various places throughout this specification are not necessarily referring to the same embodiment.

The illustrated embodiments described herein will be best understood by reference to the drawings, wherein like parts are designated by like numerals throughout. The following description is intended only by way of example, and simply illustrates certain selected embodiments of devices, systems, and processes that are consistent with the claims herein.

A distributed marsupial robotics system includes a collection of component robots that operate within a hierarchical framework. Specifically, the system may include one or more parent components (referred to herein as a “parent” or “parents”), and one or more child components (referred to herein as a “child” or “children”) each associated with a respective parent. In one embodiment, the system may further include one or more grandchild components (referred to herein as a “grandchild” or “grandchildren”) each associated with a respective child component. In yet another embodiment, the system my further include one or more great-grandchild components each associated with a respective grandchild component. Accordingly, a marsupial robotics system may be designed to accommodate any number of “generations” of components.

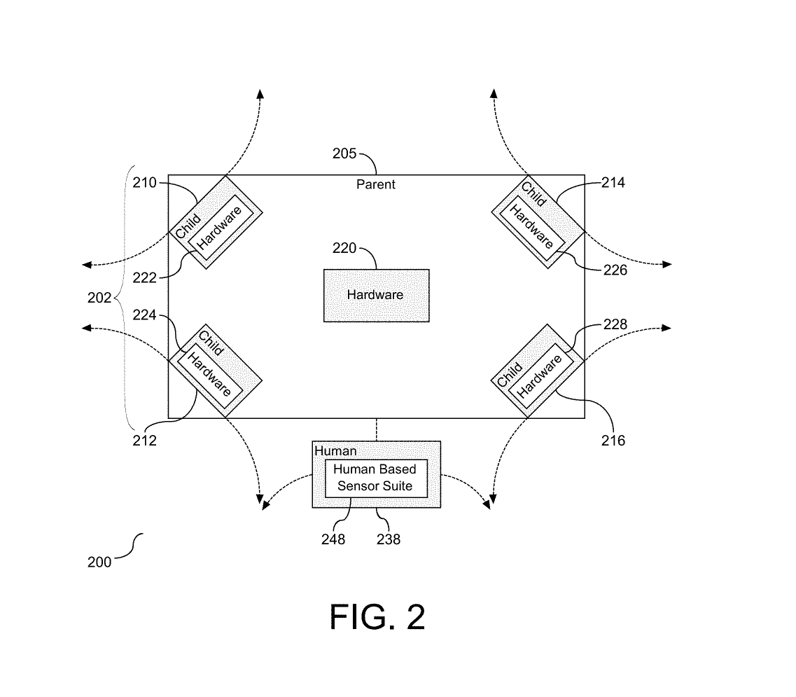

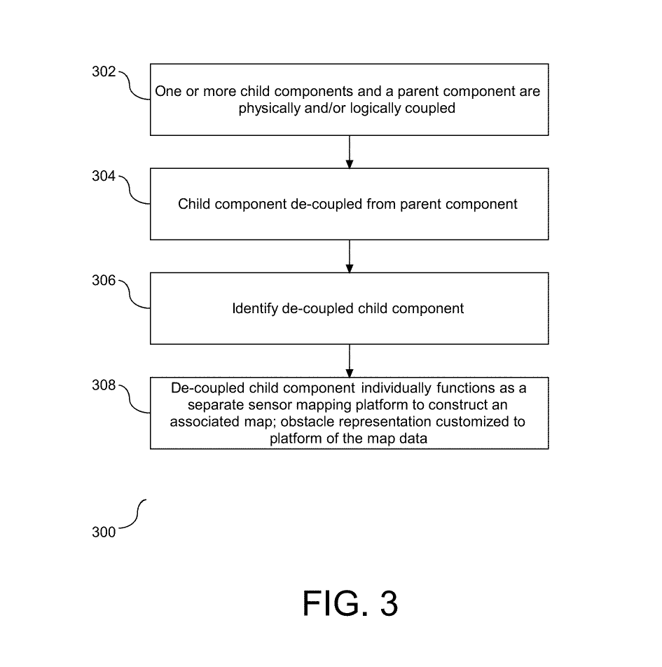

The various components of the system (e.g., the parent(s) and associated child(ren)) may work in tandem to gather data associated with a surrounding environment. For example, components of the system may be used to gather data associated with people, weapons, consumer objects, buildings, vehicles (of all types), roads and streets, animals, plants, obstacles, terrain, constellations (for night navigation), manmade and natural materials, basic geometry (e.g., lines, circles, corners, squares, etc.), basic colors, movement, etc. Further details with respect to data gathering will be discussed below with reference to FIGS. 2 and 3.

As discussed, a marsupial robotic system may be interpreted as a collection of relationships between components organized in a hierarchical fashion. Thus, each component may be associated with a particular hierarchical level. For example, in a system including one or more parent components and one or more child components, each child component is associated with a low level, and each parent component is associated with a high level. In a system including one or more parent components, one or more child components, and one or more grandchildren components, the grandchildren components may be associated with a lowest level, the child component robot may be associated with a subsequent level, and the parent component robot may be associated with a highest level. Furthermore, each lower level robotic component may be physically docked on the robot of the next level. Accordingly, there are N levels of the system hierarchy, where the N-th highest level is associated with the parent(s).

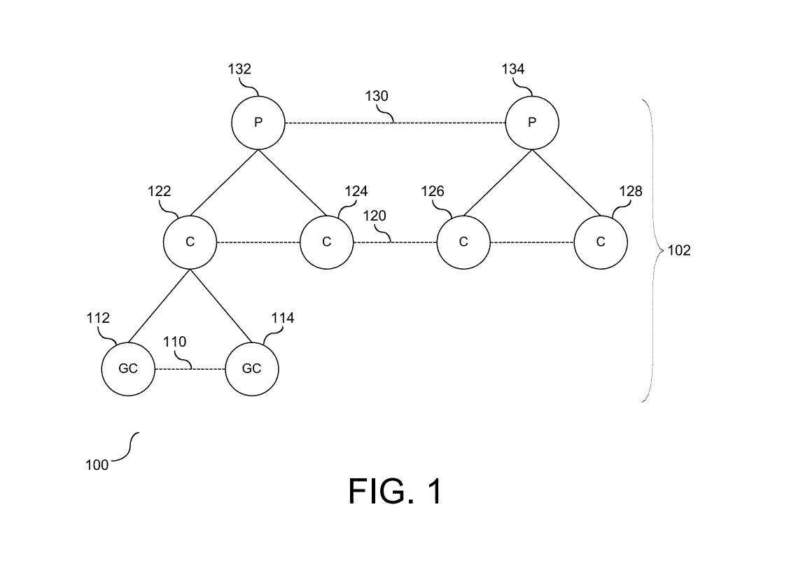

With reference to FIG. 1, a diagram (100) is provided illustrating a hierarchy (102) between components of a marsupial robotic system. As shown, the hierarchy (102) includes a plurality of levels, also referred to herein as tiers, including level₀ (110), level₁ (120), and level₂ (130). Each component of the system is illustrated in FIG. 1 as a node of the hierarchy. In particular, Level₂ (130) is associated with parent component nodes (132) and (134), level₁ (120) is associated with child component nodes (122), (124), (126), and (128), and level₀ (110) is associated with grandchild component nodes (112) and (114). However, it is to be understood that the numbers of tiers and nodes associated with components of the system shown in the hierarchy (102) of FIG. 1 are purely exemplary, and it is to be appreciated that any number of tiers and nodes may be implemented commensurate with the types of components and the number of each type in the system.

Each level has its own functionality, e.g. form of accomplishing a task, with lower generation level robots passing their data and knowledge up to a subsequent level in order to distribute mobility, sensors, and processing, or in one embodiment to pass their level directly to the root node in the system. Specifically, each component has its own set of hardware for gathering data from the surrounding environment. In one embodiment, the hardware includes a sensor suite, and a processing unit in communication with memory. Thus, each level₀ (110) component (i.e., grandchildren (112) and (114)) passes its data and knowledge up to its corresponding level₁ (120) component (e.g., child (122)) in order to distribute mobility, sensors, and processing. Furthermore, each child (122)-(128) passes its data and knowledge to an adjacent or higher level tier, shown herein as corresponding level₂ (130) component (e.g., parents (132) and (134).

In one embodiment, the sensor suites of a lower level component are a subset of the sensor suites of a higher level component. For example, each level₀ (110) component may be equipped with only having a single vision sensor and microphone. Each level₁ component may be equipped with a stereo vision sensor by using the cameras from the level₀ (110) components, and stereo audio by using two or more microphones from children (122)-(128). Likewise, each level₂ component (i.e., parents (132) and (134)) could have stereo vision, a multidimensional microphone array resourced from lower level components, as well as a two dimensional or three dimensional laser scanner local to the level₂ component. The sensor suites are configured to map the area based on the scale of the calling robot in a voxel (i.e., three-dimensional pixel) representation.

This terrain representation scaling will happen by having a set amount of lower level terrain voxels (e.g., (3×3×3, 4×4×4, etc.) contained in every higher level voxel up the chain of components. For example, a terrain voxel for a level₀ component could be a square centimeter. For a level₁ component, which in one embodiment is around four times larger than a level₀ component, a voxel may be 4×4×4 level₀ voxels. Thus, a voxel corresponding to a higher level component either contains an obstacle or does not, but to a lower level component, there will be multiple voxels inside the obstacle providing a higher three-dimensional resolution. This allows the system to more accurately find the exact location of the obstacle or object, or better identify the obstacle or object. Accordingly, the system includes a cascading set of sensor suites, with each sensor suite configured to operate based on the best representation for each type of robot.

In one embodiment, the hardware of the level₀ robots are configured to provide optics and lowest level pattern classification algorithms. These algorithms are configured to recognize and classify specific features that may be encountered and detected in real-world environments. As discussed above, these features include, but are not limited to, features of people, weapons, consumer objects, buildings, vehicles (of all types), roads and streets, animals, plants, obstacles, terrain, constellations (for night navigation), artificial and natural materials, basic geometry (e.g., lines, circles, corners, squares, etc.), basic colors, movement, etc. In one embodiment, level₀ algorithms include Convolutional Neural Networks (CNN) and Support Vector Machines (SVM). The lower level algorithms may be configured to detect different features from that of the higher level algorithms. In one embodiment, the higher level algorithms are configured to detect a proper subset of the features of the lower level algorithms. In other words, a higher level algorithm may be configured to classify fewer elements than a lower level algorithm. These levels of classification reduce data processing and transmission requirements, thereby decreasing processing latency. For example, the higher level algorithm running on a larger vehicle might only consider the largest of the navigation obstacles which were detected by the lower level algorithm as the smaller obstacles would not be large enough to impact navigation for the larger vehicle.

The hierarchical representation of algorithms may be implemented, for example, on pre-trained silicon hardware microcircuits. In alternate embodiments, the classification algorithms are implemented on one or more graphics processing unit (GPU) cores, field programmable gate arrays (FPGAs), and/or application-specific integrated circuits (ASICs). In additional alternate embodiments, the classification algorithms are implemented via software having instructions executable by a processing unit. Such implementations may provide an ability to resolve multiple objects in a high definition (HD) image in real-time due to an increase in processing time and power.

Specifically, by having multiple lower level components performing these algorithms at the same time, an environment may be resolved in three-dimensions faster than in a conventional system arrangement. In one embodiment, the hardware of the level₀ component(s) includes an array of chips configured to perform the processing algorithms discussed above. The processing load to perform the image processing may be shared among the lower level components to increase mapping efficiency, and efficiency in searching for an objective.

As its name suggests, in a marsupial robotics system, each child may be attached, or docked, to its corresponding parent. Generally speaking, each lower level component may be docked to its corresponding higher level component. With reference to FIG. 2, a block diagram is provided illustrating an overhead view of an exemplary distributed marsupial robotics system (200) having two tiers of components, including a parent tier and a child tier. As shown, the system (200) includes a parent component (205), and child components (210), (212), (214), and (216). Although one parent and four children are depicted in FIG. 2, it is to be understood that the system (200) represented herein is purely exemplary, and it is to be appreciated that any number of parents and corresponding children may be implemented in a distributed marsupial robotic system. Each of the child components (210)-(216) are shown operatively coupled or in communication with the parent component (205). Such coupling and communication may be electrical, mechanical, or combinations thereof. For example, in one embodiment, the coupling includes the ability for the child components (210)-(216) to mechanically link together with the parent component (205) to carry a larger single payload, or to traverse terrain that the child components (210)-(216) are not capable of traversing individually.

In the example shown herein, the parent component (205) is in the form of a surface vehicle. The child components (210)-(216) may be aerial vehicles, ground vehicles, amphibious vehicles, marine surface vehicles, marine subsurface vehicles, or combinations thereof. The parent component (205) may be designed to be autonomous (i.e., self-controlling or self-guiding), and/or may be manually controlled. Moreover, each child component (210)-(216) may be designed to be autonomous and/or may be manually controlled. Accordingly, the components of the system (202) may be designed to be fully autonomous, non-autonomous, or semi-autonomous.

As briefly mentioned above in FIG. 1, one function of the marsupial robotic system (202) is to gather and process data of the surrounding environment. Each component of the system (202) has hardware to support and enable the aspect of gathering data. As shown, parent component (205) has hardware (220), child component (210) has hardware (222), child component (212) has hardware (224), child component (214) has hardware (226), and child component (216) has hardware (228). In one embodiment, the hardware includes a sensor suite and a processing unit for the sensor suite in communication with memory. The sensor suite may include one or more visual sensors (e.g., cameras), one or more audio sensors (e.g., microphones), one or more thermal sensors, etc.) Further details with respect to the sensor suite will be provided below with reference to FIG. 3.

The sensor suite will primarily use machine vision, but may further include scanning range finders to include laser, radar, sonar, and/or other active sensing technologies. Furthermore, the child components (210)-(216) may be equipped with additional hardware designed to increase image recognition and machine vision to observe and analyze its surrounding area. Each child component, also referred to herein as a lower level robot, is autonomous and functional due to their sensor suite and on-board processing unit designed for low level movement.

Child components (210)-(216) are shown docked on the parent component (205) (i.e., in a docked state). Since there are four child components (210)-(216) shown, they may be viewed as “quarter panels” of the parent component (205). For instance, and as shown, when docked on the parent component (205), each child component (210)-(216) will cover overlapping sections of sensor field of view to provide primary or secondary sensing for the parent component. The overlap of the field of view may be in a variety of configurations, including but not limited to horizontal, vertical, diagonal, or linear combinations thereof. Thus, when the child components (210)-(216) are docked to parent component (205), the hardware (220)-(228) will function as a collaborative unit to provide analysis of the surrounding area. In one embodiment, the data gathered by the child components, e.g. child robots, may be supplemental. Accordingly, each component in the marsupial system has a different sensor suite configured to gather different data, which when combined provides a comprehensive data set.

In the example shown herein, the marsupial robot is in the form of a vehicle, and may be subject to movement across a terrain. For example, the parent component (205) may serve as transport for the child components (210)-(216) while the child components (210)-(216) are docked to the parent. Upon reaching, for example, a destination, the child component (210-(216) may be separated from the parent component (205) for deployment. In one embodiment, a subset of the child components may be deployed from the parent component at the destination. The deployment may be performed in order to further analyze the surrounding environment more effectively. For example, if the parent component (205) is too large to fit inside a target environment, one or more of the child components (210)-(216) may be detached from the parent component (205) to gather data within the target environment. When the child component (210)-(216) are deployed, the parent component (205) may maintain its ability to move and function by using its sensor suite, and may support wireless communication with the child component (210)-(216). Examples of wireless communication include, but are not limited to, Wi-Fi, Bluetooth, ZigBee, satellite (RF), cellular, etc.

In one embodiment, the child component (210)-(216) perform simultaneous locating and mapping (SLAM) by using pattern classification algorithms configured to recognize and classify specific features found in real-world environments. Each child component (210)-(216) continues to do SLAM even if not under its own mobility power (i.e., when the child component does not guide its own mobility, it still supports SLAM). When docked, each child component (210)-(216) is connected to the parent component (205) to provide frame-by-frame object recognition to a processing unit of the parent component (205), thereby distributing computational load. The processing unit of the parent component (205) may then integrate this data to perform high-level SLAM and obstacle avoidance. Each component tier has all the logic functionality of lower component tiers, and each tier is capable of autonomous navigation using SLAM. Each tier will also have benefits and limitations due to size, speed of movement, and sensor capability. According, the system (202) will allow for a large degree of freedom to navigate and explore any possible environment.

The child components (210)-(216) and the parent component (205) function as a suite of sensors when the child components (210)-(216) are individually decoupled from the parent component (205), or in one embodiment, de-coupled as a group. Referring to FIG. 3, a flow chart (300) is provided illustrating a de-coupling of a child component from the parent component. As shown, one or more child components and a parent component are physically and/or logically coupled, with the coupling enabling the respective sensors to function as a suite of sensors (302). A child component may be de-coupled from the parent component (304). In one embodiment, each child component may be separately de-coupled from the parent component. Similarly, in one embodiment, two or more child components may be collectively de-coupled from the parent component. Each child component detected to have been de-coupled from the parent component is identified (306), and in one embodiment a connection or communication is maintained or established with the parent component. The de-coupling of the sensor suite enables the each de-coupled child component to individually function as a separate sensor mapping platform to construct an associated map (308). More specifically, the child sensor suite obtains and processes environment data via both child and parent pattern classification algorithms. Map construction for a non-parent, such as one or more child components (210)-(216), employs customization of obstacle representation to an associated platform of the map data. The customization incorporates different geometric fidelity representation based on the platform utilizing the map. For example, a child robot will receive map obstacle representation for objects that are or may be an obstacle for the child component, although not for the parent component. As such, this same object representation on a map for the parent component may not be depicted as an obstacle for the parent component.

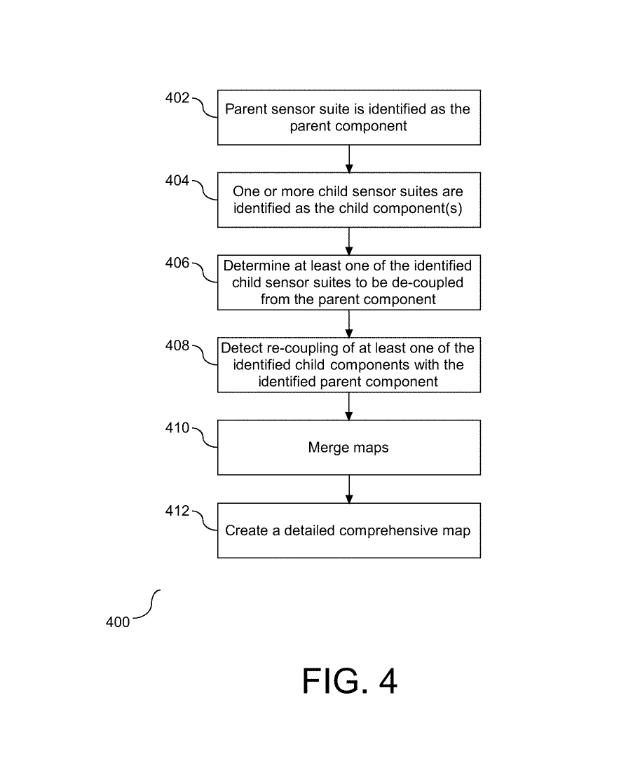

It is understood that a child component may be coupled or re-coupled to a parent component. Referring to FIG. 4, a flow chart (400) is provided illustrating a coupling of a child component with a parent component. A parent sensor suite is identified as the parent component (402). Similarly, one or more child sensor suites are identified as the child component(s) (404). At least one of the identified child sensor suites is determined to be de-coupled from the parent component (406). See FIG. 3 referring to the de-coupling detection and associated functionality. A re-coupling of at least one of the identified child components with the identified parent component is detected (408). The re-coupling at step (408) may be logical and/or physical, with one child component coupling with the parent component. In one embodiment, the re-coupling at step (408) is a coupling of two or more child components joining to form a new parent component with one of the joined child components selected to conduct parent decision processing and effectively to function as the parent component. As shown and described in FIG. 3, each child sensor suite may individually invoke their sensor to construct a map, referred to herein as a child map. At such time as individual de-coupled child component (s) (210)-(216), or the children as a group, are re-coupled to the parent component (205), the individual maps may be merged (410), thereby creating a detailed and comprehensive map (412).

In an alternate embodiment, coupling mechanisms may be universal or gender neutral such that two or more child components may physically and logically join to form a new parent component. When multiple child components join to form a new parent component, one of the joined child components is automatically configured to be the parent component with respect to higher level decision making. Child components may join to facilitate higher single payload capacity, the distribution or redistribution of data and/or power, or to increase mobility with respect to obstacles or range.

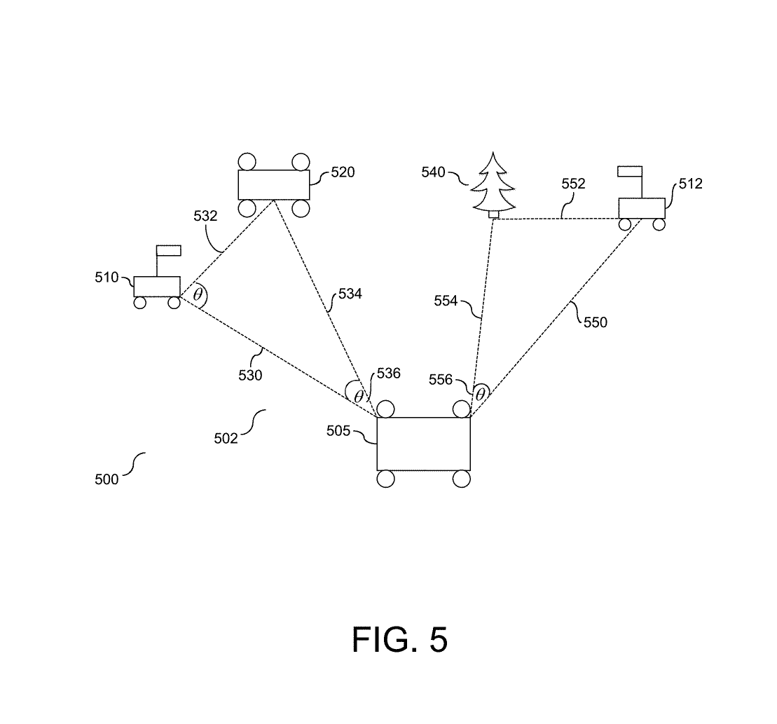

Mapping may take the form of depth mapping of the environment where the child components (210)-(216) may contribute terrain depth information based on the on-board sensors of the sensor suite and location relative to the parent component (205). This multi-camera mapping works similar to stereo vision optics, but by implementing sensors in multiple locations with known relative locations. In one embodiment, the relative locations are calculated by incorporating a combination of visual and RF information into RF and visual based distance estimation algorithms. Further details with respect to multi-camera mapping will be provided below with reference to FIG. 5.

Each of the child components shown herein demonstrates a robotic micro-system. In addition to the robotic components of the system (202), a human (238) may serve as an additional system component, and in one embodiment may function as a form of a child robotic asset in communication with the parent component (205). As shown, the human (238) is configured with hardware (248), such as a sensor suite, a mounted camera, and machine vision, with the associated hardware integrated into marsupial system. The human based sensor suite (248) enables the human (238) to function as an additional child of the parent component (205), and would connect to the parent in a similar manner as child components (210)-(216). In one embodiment, the hardware (248) includes an audio microphone sensor to support mono or stereo audio and, when docked with the parent component (205), will provide three-dimensional localization of audio sources.

With reference to FIG. 5, a block diagram (500) is provided illustrating an example of multi-camera mapping. The system (502) shown in FIG. 5 includes parent component (505), child component (510), and child component (512). As shown, both of the children component robots (510) and (512) are in a deployed state and physically detached from the parent component (505). One or more of the child component (510) and (512) may direct their visual sensors at a nearby terrain feature or object to provide depth to a visual map of the parent component vehicle.

For example and as shown, child robot component (510) is directing its visual sensor (e.g., camera) at a secondary ground vehicle (520), and activates the sensor to acquire an image of the ground vehicle (520). The distance (530) between the parent component (505) and the child component (510) is a known quantity. The distance (532) between the child component (510) and the vehicle (520) may be calculated by the child component (510) via a distance estimation algorithm based on data obtained by its visual sensor. The distance (534) between the parent component (505) and the vehicle (520) cannot be estimated by merely knowing distances (530) and (532). However, angle (536) formed between distance (530) and distance (534) is known. As such, distances (530), (532), and (534) may be viewed as formation of a triangle, and distance (534) may be estimated by utilizing trigonometric principles.

Additionally, child component (512) is shown directing its visual sensor (e.g., camera) at an object (540), shown herein as a tree, to take an image of the object (540). The distance (550) between the parent component (505) and the child component (512) is a known quantity. The distance (552) between the child component (512) and the object (540) may be calculated by the child component (512) via a distance estimation algorithm based on data obtained by its visual sensor. The distance (554) between the parent component (505) and the object (540) cannot be estimated by merely knowing distances (550) and (552). However, angle (556) formed between distance (550) and distance (554) is known. Since distances (550), (552), and (554) may be viewed as a triangle, distance (554) may be estimated by utilizing trigonometric principles. Accordingly, the parent component of a distributed marsupial robotic system may be able to map out a terrain by integrating visual data obtained by its child components.

In one embodiment, angles (536) and (556) may be dynamically changed in order to estimate the distances to various parts of the vehicle (520) and the object (540). Accordingly, by using images of terrain features or objects taken by children robots of the marsupial while deployed from the parent component, distance from the parent component to various parts the features or objects can be estimated based on the estimated distance from the child robot component to the object and the corresponding calculated pixels per area (e.g., pixels per square inch).

Referring back to FIGS. 2-4, map construction may occur with or without a real-time link between the parent component (205) and the child components (210)-(216) via a distributed map construction process. Each child component (210)-(216) may perform an individual map construction associated with its field of view. If there is a real-time link established, then the parent component (205) may construct an entire map in real-time from the individual map constructions. However, if there is no real-time child link, then the child components (210)-(216) may transfer their individual map constructions to the parent component (205) upon docking, and the parent component (205) may then be able to combine the individual map constructions into the entire map construction. Similarly, map construction for a non-parent, such as child components (210)-(216), employs customization of obstacle representation to an associated platform of the map data. The customization incorporates different geometric fidelity representation based on the platform utilizing the map. For example, a child robot will receive map obstacle representation for objects that are or may be an obstacle for the child, although not for the parent. As such, this same object representation on a map for the parent may not be depicted as an obstacle for the parent. Accordingly, the system (202) is configured to support distributed mapping and map construction regardless of an active connection between the parent component (205) and the child components (210)-(216), with the mapping system having different geometric fidelity representation based on the platform utilizing the map.

The fidelity of the sensors and complexity of the computation is proportional to the robotic asset. For example, it is understood that a child robot is physically smaller than a parent component. The sensors and complexity of computation is limited by the physical processing parameters of the asset, which in one embodiment is proportional to the physical stature of the asset within the marsupial system. Furthermore, the marsupial configuration enables the assets to couple or re-couple, both physically and/or logically, to facilitate perception of a larger asset.

Communication between the parent component (205) and the child components (210)-(216) may be wired and/or wireless. In one embodiment, wired communication between the parent component (205) and the child components (210)-(216) may include implementation of tethered fiber optic cables. The tethered cables may be data only cables or may also provide power. As discussed above, wireless communication between the parent component (205) and the child components (210)-(216) may include, but is not limited to, implementation of Wi-Fi, Bluetooth, ZigBee, satellite (RF), cellular, etc. As further discussed above, the child components (210)-(216) may operate completely autonomously even if there is no wireless connection, or when the wireless connection is lost. However, the ability for one or more operators to map control to one or more of the parent component (205) and/or child components (210)-(216) will remain in place with a connection. Mapping of operators to components may be, for example, 1:1, one to many, or many to one.

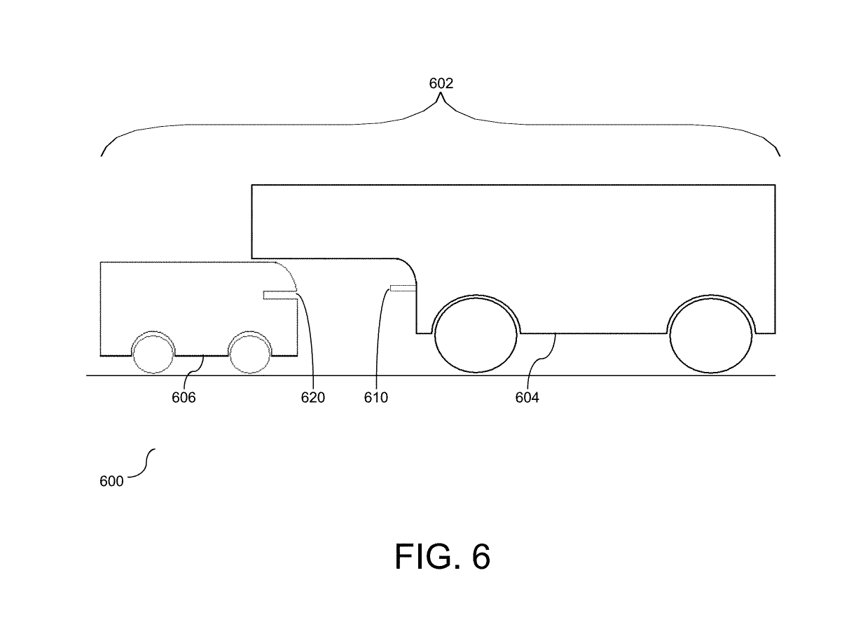

As discussed above, each child component is configured to be docked to the parent component. With reference to FIG. 6, a block diagram (600) is provided illustrating an exemplary mechanism for enabling docking of the child component to the parent component. As shown, the system (602) includes parent component (604) and child component (606). It is to be understood that child component (606) is being shown here purely for illustrative purposes, and it is to be appreciated that any number of children, grandchildren, etc. may be components of the system (602).

The child component (606) is shown deployed from the parent component (604). However, as discussed above in FIG. 2, the child component (606) may be configured to dock to the parent component (604). For example, the child component (606) may be docked to the parent component (604) during transportation to a secondary location. As shown, the parent component (604) includes a probe (610), and the child component includes a receiver (620). The probe (610), when inserted into the receiver (620), is configured to raise the child component (606) off the ground during transportation. In one embodiment, the probe (610) is designed to have a single degree of freedom. The probe—receiver implementation functions as a coupling between the parent component and child component, and in one embodiment may function as a communication link between the entities.

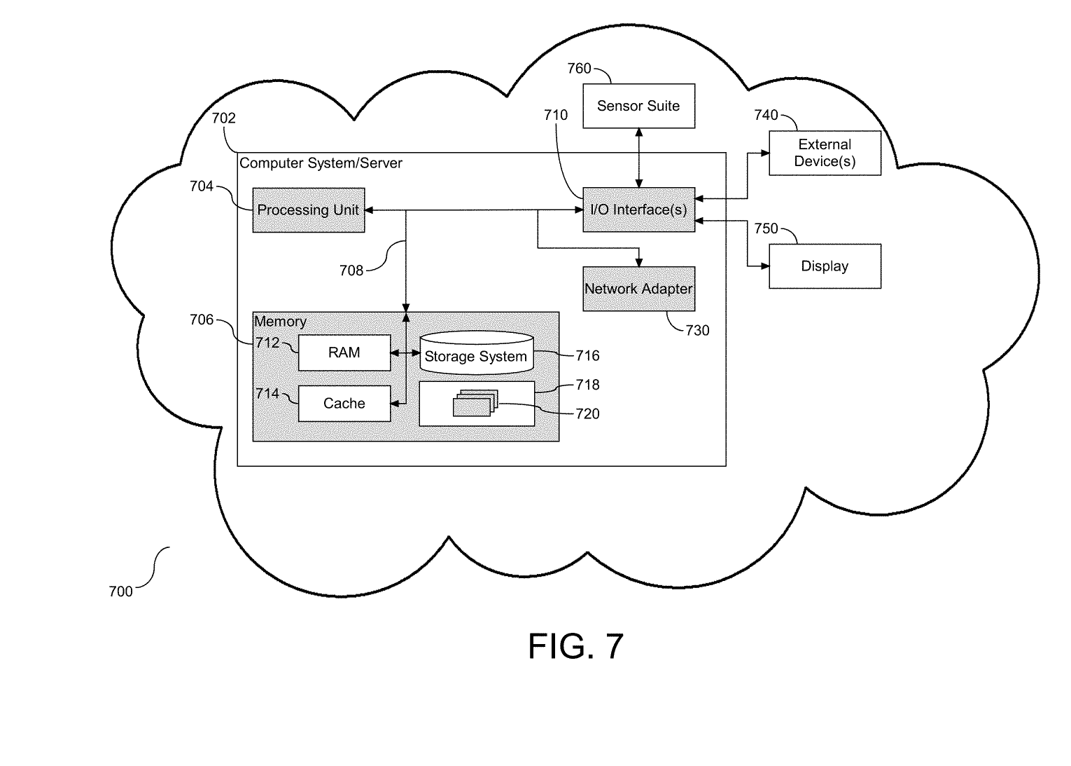

With reference to FIG. 7, a block diagram (700) is provided illustrating an example of component hardware (702) of a distributed marsupial robotic system. Hardware (702) is operational with numerous other general purpose or special purpose computing system environments or configurations. Examples of well-known computing systems, environments, and/or configurations that may be suitable for use with hardware (702) include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and filesystems (e.g., distributed storage environments and distributed cloud computing environments) that include any of the above systems or devices, and the like.

Hardware (702) may be described in the general context of computer system-executable instructions, such as program modules, being executed by a computer system. Generally, program modules may include routines, programs, objects, components, logic, data structures, and so on that perform particular tasks or implement particular abstract data types. Hardware (702) may be practiced in distributed cloud computing environments where tasks are performed by remote processing devices that are linked through a communications network. In a distributed cloud computing environment, program modules may be located in both local and remote computer system storage media including memory storage devices.

As shown in FIG. 7, hardware (702) is shown in the form of a general-purpose computing device. The components of hardware (702) may include, but are not limited to, one or more processors or processing units (704), a system memory (706), and a bus (708) that couples various system components including system memory (706) to processor (704). Bus (708) represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus. Hardware (702) typically includes a variety of computer system readable media. Such media may be any available media that is accessible by hardware (702) and it includes both volatile and non-volatile media, removable and non-removable media.

Memory (706) can include computer system readable media in the form of volatile memory, such as random access memory (RAM) (712) and/or cache memory (714). Hardware (702) further includes other removable/non-removable, volatile/non-volatile computer system storage media. By way of example only, storage system (716) can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus (708) by one or more data media interfaces. As will be further depicted and described below, memory (706) may include at least one program product having a set (e.g., at least one) of program modules that are configured to carry out the functions of the embodiments described above with reference to FIGS. 1-6.

Program/utility (718), having a set (at least one) of program modules (720), may be stored in memory (706) by way of example, and not limitation, as well as an operating system, one or more application programs, other program modules, and program data. Each of the operating systems, one or more application programs, other program modules, and program data or some combination thereof, may include an implementation of a networking environment. Program modules (720) generally carry out the functions and/or methodologies of embodiments as described herein. For example, the set of program modules (720) may include at least one module that is configured to gather and process data of a surrounding environment, and to implement the various algorithms described above herein.

Hardware (702) may also communicate with one or more external devices (740), such as a keyboard, a pointing device, etc.; a display (750); one or more devices that enable a user to interact with hardware (702); and/or any devices (e.g., network card, modem, etc.) that enable hardware (702) to communicate with one or more other computing devices. Such communication can occur via Input/Output (I/O) interface(s) (710). Still yet, the hardware (702) can communicate with one or more networks such as a local area network (LAN), a general wide area network (WAN), and/or a public network (e.g., the Internet) via network adapter (730). As depicted, network adapter (730) communicates with the other components of hardware (702) via bus (708).

A sensor suite (760) is shown in communication with the hardware (702) via the I/O interface (710) or via the network adapter (730). In one embodiment, the sensor suite (760) includes a set of sensor devices. The set of sensor devices may include, for example, one or more visual sensors (e.g., cameras), one or more audio sensors (e.g., microphones), one or more thermal sensors, etc. The sensor suite (760) obtains data from a surrounding environment, such as terrain feature data, terrain object data, etc., which may be used to construct a map of the surrounding environment, as discussed above with reference to FIGS. 1-6.

It should be understood that although not shown, other hardware and/or software components could be used in conjunction with hardware (702). Examples, include, but are not limited to: microcode, device drivers, redundant processing units, external disk drive arrays, RAID systems, tape drives, and data archival storage systems, etc.

Data associated with the marsupial robotic system may be stored locally in the parent component, or communicated from the parent component to a remote location. In one embodiment, the data may be communicated from the marsupial robotic elements to a node of a cloud computing environment. With the data stored in a cloud based storage device, processing and manipulation of the data may take place with the use of cloud based resources, thereby mitigating the processing local to the robotic system, and further enabling the marsupial robot to continue its local functionality with sufficient bandwidth of the marsupial components.

As shown and described in FIG. 7, the data storage and processing of data associated with the marsupial robotic system may be supported with cloud based resources. As is known in the art, cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. One or more components of the marsupial robotic system may be configured with a communication platform that supports communication with externally available shared resources (e.g. cloud supported products and services), also referred to herein as a cloud model. This cloud model may include at least five characteristics, at least three service models, and at least four deployment models. Example of such characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure comprising a network of interconnected nodes.

Referring to FIG. 7, the component hardware (702) may be a server node in the cloud computing environment. The cloud computing node is only one example of a suitable cloud computing node and is not intended to suggest any limitation as to the scope of use or functionality of embodiments described herein. Regardless, the cloud computing node is capable of being implemented and/or performing any of the functionality set forth hereinabove.

The cloud computing node (702) is a computer system/server, which is operational with numerous other general purpose or special purpose computing system environments or configurations. Examples of well-known computing systems, environments, and/or configurations that may be suitable for use with computer system/server (702) include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server (702) may be described in the general context of computer system executable instructions, such as program modules, being executed by a computer system. Generally, program modules may include routines, programs, objects, components, logic, data structures, and so on that perform particular tasks or implement particular abstract data types. Computer system/server (702) may be practiced in distributed cloud computing environments where tasks are performed by remote processing devices that are linked through a communications network. In a distributed cloud computing environment, program modules may be located in both local and remote computer system storage media including memory storage devices.

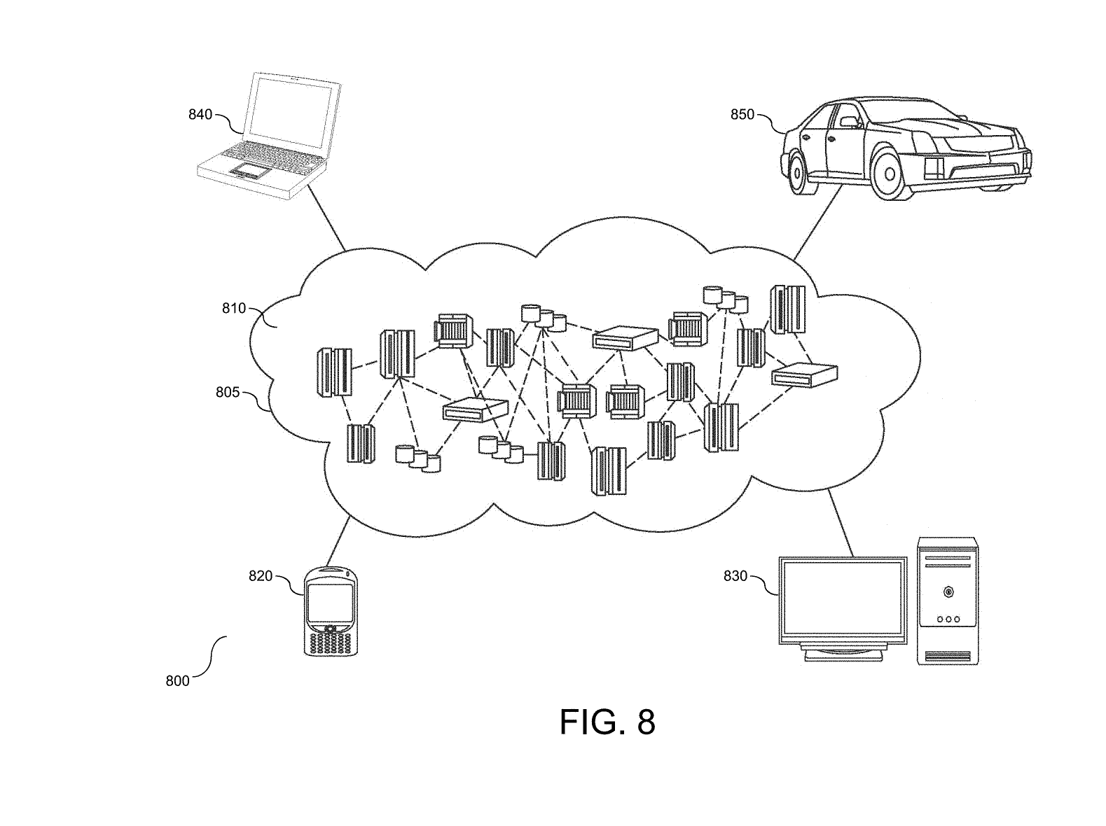

Referring now to FIG. 8, a diagram (800) is provided depicting an illustrative cloud computing environment (805). As shown, cloud computing environment (805) comprises one or more cloud computing nodes (910) with which local computing devices used by cloud consumers, such as, for example, personal digital assistant (PDA) or cellular telephone (920), desktop computer (830), laptop computer (840), and/or automobile computer system (850) may communicate. Nodes (810) may communicate with one another. They may be grouped (not shown) physically or virtually, in one or more networks, such as Private, Community, Public, or Hybrid clouds as described hereinabove, or a combination thereof. This allows cloud computing environment (805) to offer infrastructure, platforms and/or software as services for which a cloud consumer does not need to maintain resources on a local computing device. It is understood that the types of computing devices (820)-(850) shown in FIG. 8 are intended to be illustrative only and that computing nodes (810) and cloud computing environment (805) can communicate with any type of computerized device over any type of network and/or network addressable connection (e.g., using a web browser).

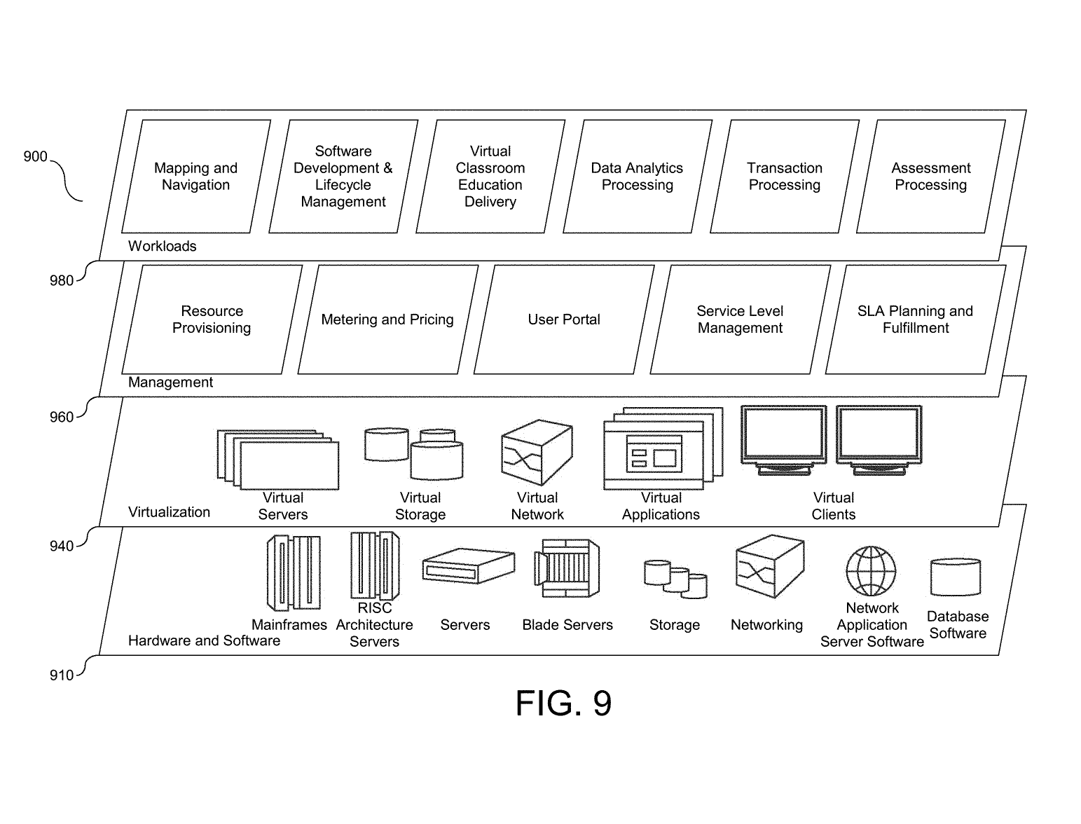

Referring now to FIG. 9, a set of functional abstraction layers (900) provided by cloud computing environment (800) of FIG. 8 is shown. It should be understood in advance that the components, layers, and functions shown in FIG. 9 are intended to be illustrative only and embodiments are not limited thereto. As depicted, the following layers and corresponding functions are provided:

Hardware and software layer (910) includes hardware and software components. Examples of hardware components include mainframes; RISC (Reduced Instruction Set Computer) architecture based servers; servers; blade servers; storage devices; and networks and networking components. In some embodiments, software components include network application server software and database software.

Virtualization layer (940) provides an abstraction layer from which the following examples of virtual entities may be provided: virtual servers; virtual storage; virtual networks, including virtual private networks; virtual applications and operating systems; and virtual clients.

In one example, management layer (960) may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provides pre-arrangement for, and procurement of, cloud computing resources for which a future requirement is anticipated in accordance with an SLA.

Workloads layer (980) provides examples of functionality for which the cloud computing environment may be utilized. Examples of workloads and functions which may be provided from this layer include: mapping and navigation; software development and lifecycle management; virtual classroom education delivery; data analytics processing; transaction processing; and assessment processing of one or more aspects of the present embodiments.

As will be appreciated by one skilled in the art, the aspects may be embodied as a system, method, or computer program product. Accordingly, the aspects may take the form of an entirely hardware embodiment, an entirely software embodiment (including firmware, resident software, micro-code, etc.), or an embodiment combining software and hardware aspects that may all generally be referred to herein as a “circuit,” “module,” or “system.” Furthermore, the aspects described herein may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, an electronic storage device, magnetic storage device, optical storage device, an electromagnetic storage device, a semiconductor storage device or system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read only memory (EPROM or Flash memory), a static random access memory (SRAM), an optical fiber, a portable compact disc read-only memory (CD-ROM), a digital versatile disk (DVD), an optical storage device, a magnetic storage device, or any suitable combination of the foregoing. In the context of this document, a computer readable storage medium may be any tangible medium that can contain, or store a program for use by or in connection with an instruction execution system, apparatus, or device. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for the embodiments described herein may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The embodiments are described above with reference to flow chart illustrations and/or block diagrams of methods, apparatus (systems), and computer program products. It will be understood that each block of the flow chart illustrations and/or block diagrams, and combinations of blocks in the flow chart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flow chart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flow chart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions, which execute on the computer or other programmable apparatus, provide processes for implementing the functions/acts specified in the flow chart and/or block diagram block or blocks.

The flow charts and block diagrams in the Figures illustrate the architecture, functionality, and operation of possible implementations of systems, methods, and computer program products according to various embodiments. In this regard, each block in the flow charts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flow chart illustration(s), and combinations of blocks in the block diagrams and/or flow chart illustration(s), can be implemented by special purpose hardware-based systems that perform the specified functions or acts, or combinations of special purpose hardware and computer instructions.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The embodiments described herein may be implemented in a system, a method, and/or a computer program product. The computer program product may include a computer readable storage medium (or media) having computer readable program instructions thereon for causing a processor to carry out the embodiments described herein.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmissions, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

The embodiments are described herein with reference to flow chart illustrations and/or block diagrams of methods, apparatus (systems), and computer program products. It will be understood that each block of the flow chart illustrations and/or block diagrams, and combinations of blocks in the flow chart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flow chart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flow chart and/or block diagram block or blocks.

The corresponding structures, materials, acts, and equivalents of all means or step plus function elements in the claims below are intended to include any structure, material, or act for performing the function in combination with other claimed elements as specifically claimed. The description of the embodiments herein has been presented for purposes of illustration and description, but is not intended to be exhaustive or limited to the embodiments in the forms disclosed. Many modifications and variations will be apparent to those of ordinary skill in the art without departing from the scope and spirit of the embodiments described herein. The embodiments were chosen and described in order to best explain the principles and the practical application, and to enable others of ordinary skill in the art to understand the various embodiments with various modifications as are suited to the particular use contemplated.

It will be appreciated that, although specific embodiments have been described herein for purposes of illustration, various modifications may be made without departing from the spirit and scope of the specific embodiments described herein. Accordingly, the scope of protection is limited only by the following claims and their equivalents.

What is claimed is:

1. A marsupial robotic system comprising:
a parent component, wherein the parent comprises a parent sensor suite to obtain and process environment data via a parent pattern classification algorithm, wherein the parent sensor suite comprises one or more parent sensor devices in communication with a parent processing unit and parent memory;
one or more child components in communication with the parent component, wherein each child component comprises a respective child sensor suite to obtain and process environment data via respective child pattern classification algorithms, wherein each child sensor suite comprises one or more child sensor devices in communication with a local child processing unit and local child memory, and wherein each child communicates with the parent by communication means selected from the group consisting of: wireless, wired, and a combination thereof;
wherein each child component is configured to dock to the parent component, and to separate from the parent component in response to a deployment signal, and to obtain environment data during separation; and
one of the components to employ a map application to construct a map of the environment, the map application having different geometric fidelity representation based on a platform utilizing the map application.

2. The system of claim 1, wherein the fidelity representation customizes one or more objects represented in the constructed map to a platform designated to receive the map.

3. The system of claim 2, further comprising a de-coupling of the child component from the parent component, and the de-coupled child component to function as an independent component after the de-coupling.

4. The system of claim 3, further comprising the de-coupled child component to employ the child sensor devices, activate the map application, and construct a child map with data acquired from the child sensor devices.

5. The system of claim 4, further comprising the de-coupled child component to re-couple with the parent component, and to merge the child map and the acquired data into a parent map with parent data acquired from the parent sensor devices.

6. The system of claim 4, further wherein fidelity of the child sensor devices and computation by the child processing unit is proportional to a physical size of the child component.

7. The system of claim 6, further comprising a logical third component in communication with the parent component, the logical third component including a coupling of at least two child components.

8. The system of claim 7, wherein the coupling is selected from the group consisting of: logical and physical.

9. The system of claim 1, further comprising each child component having overlapping sections of sensor field of view to provide sensing for the parent component.

10. The system of claim 9, wherein the overlap of the field of view includes a configuration selected from the group consisting of: horizontal, vertical, diagonal, and linear.

11. The system of claim 1, wherein the parent comprises the child sensor suite to obtain and process environment data via child and parent pattern classification algorithms, wherein the parent sensor suite comprises one or more child sensor devices in communication with a child processing unit and child memory, in communication with a parent processing unit and parent memory.

12. The system of claim 1, wherein two or more child components may join to form a new parent with one of the joined children selected to conduct parent decision processing.

13. The system of claim 1, further comprising a combination of parent and child components, including the parent and child sensor suites to conduct three dimensional mapping by estimating environmental object distance based on the parent and child components viewing a same object from multiple perspectives.

14. The system of claim 13, further comprising the parent sensor suite to estimate a position of the child component relative location, the parent sensor suite including a combination of sensor devices selected from the group consisting of: GPS, laser range finder, stereo optics, radio frequency time of flight, apparent visual size, and reported dead reckoning.

15. The system of claim 1, further comprising the child level component to invoke a child pattern classification algorithm to recognize and classify one or more features detected by the child sensor suite of the child level component.

16. The system of claim 15, further comprising the parent level component to invoke a parent classification algorithm to detect a subset of features detected and processed by one or more child level components.

17. A computer program product for a marsupial robotic system comprising:
the marsupial robotic system comprising:
a parent component, wherein the parent comprises a parent sensor suite to obtain and process environment data via a parent pattern classification algorithm, wherein the parent sensor suite comprises one or more parent sensor devices in communication with a parent processing unit and parent memory;
one or more child components in communication with the parent component, wherein each child component comprises a respective child sensor suite to obtain and process environment data via respective child pattern classification algorithms, wherein each child sensor suite comprises one or more child sensor devices in communication with a local child processing unit and local child memory, and wherein each child communicates with the parent by communication means selected from the group consisting of: wireless, wired, and a combination thereof;
wherein each child component is configured to dock to the parent component, and to separate from the parent component in response to a deployment signal, and to obtain environment data during separation; and
the computer program product comprising a computer readable storage medium having program code embodied therewith, the program code executable by a processor to:
employ a map application to construct a map of the environment, the map application having different geometric fidelity representation based on a platform utilizing the map application.

18. The computer program product of claim 17, wherein the fidelity representation employs program code to customize one or more objects represented in the constructed map to a platform designated to receive the map.

19. The computer program product of claim 18, further comprising the de-coupled child component to employ the child sensor devices, the program code to activate the map application and construct a child map with data acquired from the child sensor devices.

20. The computer program product of claim 19, further comprising the de-coupled child component to re-couple with the parent component, and the program code to merge the child map and the acquired data into a parent map with parent data acquired from the parent sensor devices.

21. The computer program product of claim 20, further wherein fidelity of the child sensor devices and computation by the child processing unit is proportional to a physical size of the child component.

22. The computer program product of claim 17, wherein the parent comprises a child sensor suite to obtain and process environment data via child and parent pattern classification algorithms, wherein the parent sensor suite comprises one or more child sensor devices in communication with a child processing unit and child memory, in communication with a parent processing unit and parent memory.

23. The computer program product of claim 17, wherein two or more child components may join to form a new parent with program code to select one of the joined children to conduct parent decision processing.

24. The computer program product of claim 17, further comprising a combination of parent and child components, including the parent and child sensor suites to conduct three dimensional mapping with program code estimating environmental object distance based on the parent and child components viewing a same object from multiple perspectives.

25. The computer program product of claim 24, further comprising the parent sensor suite to estimate a position of the child component relative location, the parent sensor suite including a combination of sensor devices selected from the group consisting of: GPS, laser range finder, stereo optics, radio frequency time of flight, apparent visual size, and reported dead reckoning.

26. The computer program product of claim 17, further comprising the child level component to invoke a child pattern classification program code to recognize and classify one or more features detected by the child sensor suite of the child level component.

27. The computer program product of claim 26, further comprising the parent level component to invoke a parent classification program code to detect a subset of features detected and processed by one or more child level components.

28. A method comprising:
configuring a plurality of components as a marsupial robotic system, the configuration including:
designating a component as a parent component, wherein the parent comprises a parent sensor suite to obtain and process environment data via a parent pattern classification algorithm, wherein the parent sensor suite comprises one or more parent sensor devices in communication with a parent processing unit and parent memory;
designating one or more child components in communication with the parent component, wherein each child component comprises a respective child sensor suite to obtain and process environment data via respective child pattern classification algorithms, wherein each child sensor suite comprises one or more child sensor devices in communication with a local child processing unit and local child memory, and wherein each child communicates with the parent by communication means selected from the group consisting of: wireless, wired, and a combination thereof;
configuring each designated child component to dock to the parent component, and to separate from the parent component in response to a deployment signal, and to obtain environment data during separation; and
constructing a map of the environment by one of the components via a map application, the map having different geometric fidelity representation based on a platform utilizing the map application.

29. The method of claim 28, wherein the fidelity representation customizes one or more objects represented in the constructed map to a platform designated to receive the map.

30. The method of claim 29, further comprising de-coupling of the child component from the parent component, and the de-coupled child component to function as an independent component after the de-coupling.

31. The method of claim 30, further comprising the de-coupled child component employing the child sensor devices, activating the map application, and constructing a child map with data acquired from the child sensor devices.

32. The method of claim 31, further comprising the de-coupled child component re-coupling with the parent component, and merging the child map and the acquired data into a parent map with parent data acquired from the parent sensor devices.

33. The method of claim 31, further wherein fidelity of the child sensor devices and computation by the child processing unit is proportional to a physical size of the child component.

34. The method of claim 33, further comprising a logical third component in communication with the parent component, the logical third component includes a coupling of at least two child components.

35. The method of claim 34, wherein the coupling is selected from the group consisting of: logical and physical.

36. The method of claim 28, further comprising each child component having overlapping sections of sensor field of view to provide sensing for the parent component.

37. The method of claim 36, wherein the overlap of the field of view includes a configuration selected from the group consisting of: horizontal, vertical, diagonal, and linear.

38. The method of claim 28, wherein the parent comprises a child sensor suite, the child sensor suite obtaining and processing environment data via child and parent pattern classification algorithms, wherein the parent sensor suite comprises one or more child sensor devices in communication with a child processing unit and child memory, in communication with a parent processing unit and parent memory.

39. The method of claim 28, wherein two or more child components join and form a new parent, and further comprising and selecting one of the joined children conducting parent decision processing.

40. The method of claim 28, further comprising a combination of parent and child components, including the parent and child sensor suites conducting three dimensional mapping by estimating environmental object distance based on the parent and child components viewing a same object from multiple perspectives.

41. The method of claim 40, further comprising the parent sensor suite estimating a position of the child component relative location, the parent sensor suite including a combination of sensor devices selected from the group consisting of: GPS, laser range finder, stereo optics, radio frequency time of flight, apparent visual size, and reported dead reckoning.

42. The method of claim 28, further comprising the child level component invoking a child pattern classification algorithm recognizing and classifying one or more features detected by the child sensor suite of the child level component.

43. The method of claim 42, further comprising the parent level component invoking a parent classification algorithm detecting a subset of features detected and processed by one or more child level components.
